(19) United States
(12) Patent Application Publication
(10) Pub. No.: US 2009/0103964 A1
(43) Pub. Date: Apr. 23, 2009

(54) Key switch arrangement having an illuminating function

(75) Inventors: Yasushi Takagi, Gunma (JP); Shigeru Yamada, Gunma (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 12/232,837

(22) Filed: Sep. 25, 2008

(30) Foreign Application Priority Data
Oct. 17, 2007 (JP) 2007-270057

(51) Int. Cl. B41J 5/00

(52) U.S. Cl. 400/495

(57) ABSTRACT

A key switch arrangement is able to accomplish the compatibility with a normal keyboard in respect of profile without increasing the height of the keyboard and reduce the cost without adding new members for a light source. The key switch arrangement includes a key-top having an optically transparent key-top having a cutout letter part formed thereon, an optically transparent membrane sheet having a contact, an optically transparent plate member arranged under the membrane sheet, and a light source arranged in the membrane sheet. The light source emits light to pass the plate member and the membrane sheet to illuminate the cutout letter part on the key-top.

### BACKGROUND OF THE INVENTION

1. Field of the Invention

The present invention relates to a key switch arrangement for use in an input device in information equipment, measuring apparatuses, medical instruments, etc., and more specifically to a key switch arrangement having an illuminating function capable of securing good operability even in a dark environment.

2. Description of the Background Art

In general, a keyboard device has been developed which is capable of securing good operability even in a dark environment. Such a type of keyboard comprises key-tops each of which has a character, letter or symbol printed thereon and constituting a key switch, a link member, a rubber dome, a membrane sheet having a contact and a back plate, as well as a baseboard or a light guide plate which has, for example, EL (Electro-Luminescence) light-emitters or LEDs (Light-Emitting Diodes) arranged in correspondence to respective key switches as light sources for illuminating the keyboard. Such a switch illuminating a key-top using an EL device as a light source is disclosed, for example, by U.S. Pat. No. 6,686,549 B2 to Douzono, et al.

Douzono, et al., uses an EL element having an optically transparent sheet, an optically transparent electrode layer, an illuminant layer and a back electrode layer arranged in order, for example, on the rear surface of a membrane sheet placed below an elastic material, so that light emitted from the illuminant layer illuminates the key-top from below through the through-hole of a baseboard arranged between the membrane sheet and the EL element.

However, since the conventional key switch arrangement of Douzono, et al., is structured to have an EL element added as a light source, the light source portion constitutes an additional space, compared to a normal keyboard, other than an illuminating type, resulting in increased overall height of the keyboard, which has been a problem. Further, since the height of the keyboard is thus different, it has been problematically difficult to mount the keyboard on a personal computer, i.e. it is difficult to substitute an illuminating type of keyboard for a normal, non-illuminating type of keyboard.

Moreover, in addition to a problem with an increased cost caused by additional components for such a light source, it has been another problem that workability worsens due to an additional process for combining the components for the light source with the key switch.

### SUMMARY OF THE INVENTION

It is an object of the present invention to provide a key switch arrangement capable of accomplishing compatibility with a normal keyboard in respect of profile without increasing the height of the keyboard and of reducing the cost without adding new members for a light source.

In accordance with the present invention, a key switch arrangement includes a key-top having a cutout character part formed thereon which is optically transparent, a membrane sheet optically transparent and having an electric contact, a plate member optically transparent and arranged under the membrane sheet, and a light source arranged in the membrane sheet, the light source emitting light to illuminate the cutout character part on the key-top through the plate member and the membrane sheet. The light source may be arranged in the membrane sheet so as to emit light toward the plate member. Further, the light source may be arranged between the key switches.

According to the present invention, since the light source is arranged in the membrane sheet, the height of a keyboard is not increased. Since there is no need of adding new members for illumination, the cost does not increase, thereby enabling the manufacture in a process similar to a conventional one.

### BRIEF DESCRIPTION OF THE DRAWINGS

The objects and features of the present invention will become more apparent from consideration of the following detailed description taken in conjunction with the accompanying drawings in which:

FIG. 1 is an exploded perspective view schematically showing a preferred embodiment of a key switch arrangement according to the present invention;

FIG. 2 is a cross-sectional view schematically showing the key switch arrangement shown in FIG. 1;

FIG. 3 is a cross-sectional view schematically showing the membrane sheet shown in FIGS. 1 and 2;

FIG. 4 schematically shows the state of an LED mounted in a conventional key switch;

FIG. 5 schematically shows the state of an LED mounted in the embodiment shown in FIG. 2;

FIG. 6 is a cross-sectional view schematically showing the state of a switch when closed in the embodiment;

FIG. 7 schematically shows an illuminating state in the embodiment;

FIG. 8 is a cross-sectional view schematically showing essential parts of an alternative embodiment of the key switch arrangement according to the present invention; and

FIG. 9 is a cross-sectional view schematically showing essential parts of another alternative embodiment of the key switch arrangement according to the present invention.

### DESCRIPTION OF THE PREFERRED EMBODIMENTS

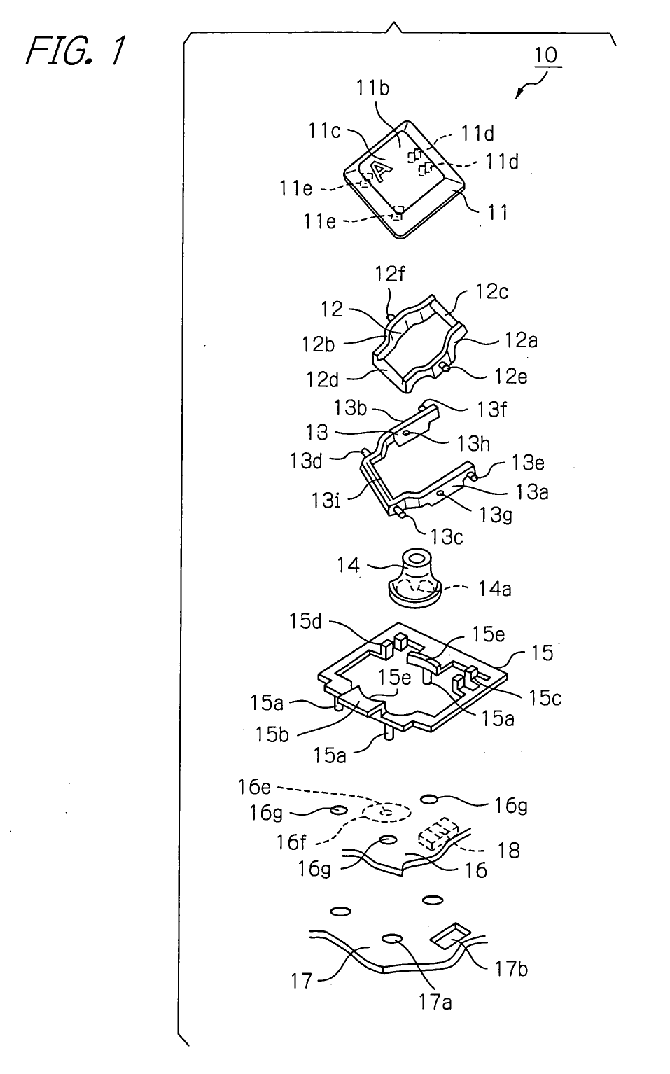

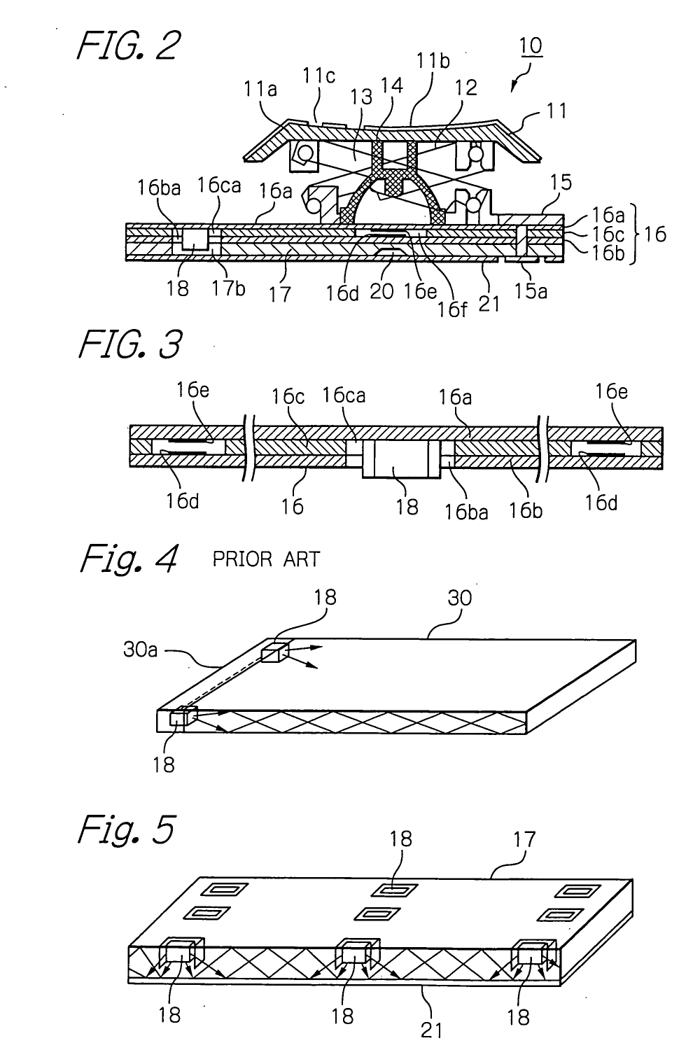

A preferred embodiment of a key switch arrangement in accordance with the present invention will be described reference to the accompanying drawings. FIG. 1 is an exploded perspective view schematically showing a key switch arrangement of an embodiment in accordance with the invention, and FIG. 2 is a cross-sectional view schematically showing the key switch arrangement of the embodiment. In FIG. 2, structural parts and elements like those shown in FIG. 1 are designated by the identical reference numerals, and will not be described repetitively in order to avoid redundancy.

In FIGS. 1 and 2, a key switch arrangement 10 in accordance with the embodiment includes a key-top 11, a first link member 12 rotatably mounted against the key-top 11, a second link member 13 mounted slidably against the key-top 11, a rubber dome 14 functioning as an elastic member to bend when the key-top is depressed and restore the key-top 11 to its original position when the depression force is released, a holder 15 for holding the first link member 12 and the second link member 13, a membrane sheet 16 having a contact right under the rubber dome 14 and a back plate, or plate member, 17 formed of material having a function of a light guide plate, i.e. transmissive property.

The key-top 11 includes, as shown in FIG. 2, a main body part 11a formed of a transparent or translucent resin optionally adjusted for the degree of light transmission, a coating part 11b formed above the main body part 11a and applied with a single-colored or multicolored coating prepared for controlling light transmission and a cutout letter part 11c on which a cutout letter, character or symbol is formed, e.g. printed, by removing part of the coating in a shape of a letter, character or symbol by means of, e.g. laser marking. The cutout letter part 11c may have any letters, characters, symbols, numerals or the like formed which may be usually printed on the surface of the key-top 11. In the context, the term “character” is sometimes broadly comprehended to cover the possibility of any possible forms or shape, such as letter, figure, symbol and mark.

On the rear surface of the key-top 11 there are provided rotary supports lid for rotatably supporting one end of the first link member and slide supports lie for supporting one end of the second link member 13 rotatably and movably in the horizontal direction, i.e. substantially in parallel with the plane formed by the back plate 17. The first link member 12 has a pair of legs 12a, 12b, which have one end provided with a first coupling rod 12c inserted into and supported by the rotary support lid of the key-top 11 in a fashion connecting between the legs 12a, 12b, and have, correspondingly, the other end provided with a second coupling 12d in a fashion connecting between the legs 12a, 12b. Further, on the respective exterior surfaces of the legs 12a, 12b there are provided shafts 12e, 12f lying on a line connecting between the first coupling rod 12c and the second coupling rod 12f and located at an equal distance from the respective coupling rods 12c, 12d.

The second link member 13 has a pair of legs 13a, 13b, which have one end outwardly provided with first supporting projection 13c, 13d supported by the slide supports rotatably and movably in parallel toward a horizontal direction, and have the other end outwardly provided with second supporting projections 13e, 13f at a distance substantially equal to a distance from both coupling rods 12c, 12d. Also, in positions lying on lines connecting between the first supporting projections 13c, 13d and the second supporting projections 13e, 13f and located at a distance equal from the respective supporting projections 13c, 13d; 13e, 13f there are provided shaft holes 13g, 13h. Further, the legs 13a, 13b are connected with a coupling 13i at the tip side far from the first supporting projections 13c, 13d.

The rubber dome 14 is made of elastic material, such as rubber, generally in a cup shape which has its internal face formed, of which the central part protrudes downward to serve as a contact depression part 14a. The holder 15 is formed into a frame shape dedicated for a single key. The holder 15 has its one end, in the vicinity of which there is provided a slide guide 15b for supporting the second coupling rod 12d of the first link member 12 rotatably and movably in parallel in the horizontal direction, while it has its opposite end, in the vicinity of which there are provided rotary guides 15c, 15d for supporting the second projections 13e, 13f of the second link member 13 in a freely rotatable fashion.

In the vicinity of the central part of the holder 15 there are arranged arcuate guide walls 15e in opposition to each other for fixing the circumference of the rubber dome 14, and in the underside of the holder 15 there are welding pins 15a having a predetermined length and formed in a plurality of places in a fashion surrounding a through-hole 16f of the membrane sheet 16.

The membrane sheet 16 is, as shown in FIG. 2, formed of an upper sheet 16a, a lower sheet 16b and a spacer sheet 16c interposed between the upper sheet 16a and the lower sheet 16b, each having flexibility. The spacer sheet 16c is provided with a plurality of through-holes 16f corresponding to the plurality of keys. The through-hole 16f forms a space between the upper sheet 16a and the lower sheet 16b, and a fixed contact 16d is provided in the lower sheet 16b on the side of the back plate 17, while a moving contact 16e is provided in the upper sheet 16a on the side of the rubber dome 14, so that they are opposed to each other in the space.

The fixed contact 16d and the moving contact 16e constitute an electric contact. In addition, as shown in FIG. 1, the membrane sheet 16 is provided with a plurality of through-holes 16g so as to be positioned around the through-holes 16f. The membrane 16 is formed, as a whole, of an optically transparent member. In the upper sheet 16a of the membrane sheet 16 there is provided an LED (Light-Emitting Diode) 18 as a light source for illumination, which will be described later.

The back plate 17 is placed lowest as seen in FIGS. 1 and 2 to mount the components described above and formed of a highly optically transparent resin, within which light passes refractively or reflectively. The back plate 17 has holes 17a penetratingly cut for passing the welding pins 15a of the holder therethrough in locations corresponding to the through-holes 16g of the membrane sheet 16. Also, in the back plate 17 a notched hole 17b is formed in a location corresponding to the LED 18 provided in the membrane sheet 16.

As shown in FIGS. 2 and 3, in a location (between the key switches) departing from the location where the key switch 10 is arranged, notched holes 16ca, 16ba are formed in the spacer sheet 16c and the lower sheet 16b, respectively, to correspond to the notched hole 17b of the back plate 17. On the lower surface of the upper sheet 16a opposite to the notched holes 16ca, 16ba, 17b, there is provided the LED 18 which functions as a light source oriented illuminating downward in the figures. The LED 18 has its height shorter than the total height of the spacer sheet 16c, the lower sheet 16b and the back plate 17, so that the lower part of the LED 18 does not protrude downward from the lower level of the back plate 17. Note that FIG. 3 is a cross-sectional view showing the membrane sheet.

The LED 18 is fixed on the upper sheet 16a of the membrane sheet 16 with an electro-conductive adhesive or the like. The LED 18 does not require a baseboard or substrate but is connected by printing in a pattern similar to that of the contact 16d, 16e of the membrane sheet 16. The back plate 17 is welded to the holder 15 with the welding pin 15a of the holder 15 by intervention of the membrane sheet 16. Formed in a location below the contacts 16d, 16e in the back plate 17 there is a reflecting part 20. The reflecting part 20 is formed in a conical shape which has its upper and side faces constituting reflective surfaces. Arranged under the back plate 17, seen in FIG. 2, there is a light reflector 21, which is bonded to the back plate 17 with an adhesive or the like, except for a portion welded with the welding pin 15a. The light reflector 21 has a function to reflect the illuminated light on the back plate 17 side.

Generally, when the LED 18 is disposed as a light source for illumination, it would be disposed at an end 30a of the light guide plate 30 in a concentrated manner, as shown in FIG. 4. For this purpose, a space dedicated for mounting the LED 18 would be required. However, when applied to a keyboard, there is no need of illuminating evenly all over its surface, but light transmission through a letter or icon printed on the key-top will suffice. Thus, in the illustrative embodiment the LED 18 is mounted between the key switches, as shown in FIG. 5, to thereby eliminate the need of a space dedicated for mounting an LED. Further, the LED 18 is thus embedded in the light guide plate, or back plate, 17, not resulting in increased thickness of the light guide plate 17. In addition, FIG. 4 shows how a conventional LED is mounted, and FIG. 5 shows how the LED of the embodiment is mounted.

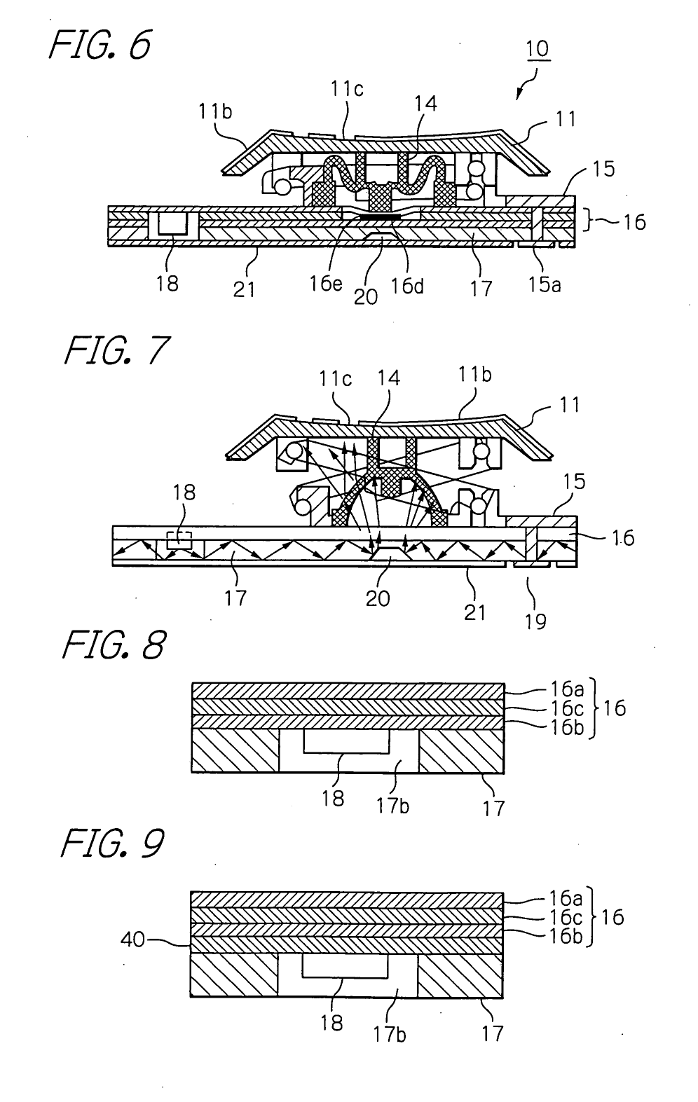

Subsequently, operation will be described. In FIG. 2, when the key-top 11 is depressed from above with an optional load, the key-top 11 moves downward, by means of which the rubber dome 14 bends or is pressed, and the contact depression part 14a of the rubber dome 14 presses, as shown in FIG. 6, the contact 16e of the membrane sheet 16. Thereby, the contact 16e is brought into contact with the contact 16d to produce the state of the switch being closed. Moreover, when any portion on the upper surface of the key-top 11 is depressed, the key-top 11 moves downward while keeping itself horizontal, which makes it possible to obtain the state of the switch being closed. FIG. 6 is a cross-sectional view showing the switch being closed.

FIG. 7 explanatorily shows an illuminating state in the embodiment. In the figure, when the LED 18 arranged in the membrane sheet 16 is lit, the light emitted from the LED 18 reflects between the upper surface of the back plate 17 and the light reflector 21 to penetrate through the interior of the back plate 17 formed of a transparent resin in the lateral direction as a whole, while being refracting. The light penetrating through the back plate 17 reflects on the upper and side surfaces of the reflecting part 20 formed right under the central part of the key-top 11. As the side surfaces of the reflecting part 20 are formed to be sloped down, the light passing through the back plate 17 reflects toward the key-top 11.

The light penetrating through the back plate 17 penetrates through the membrane sheet, because the membrane sheet 16 is optically transparent. At this instance the light passes through transparent portions around the contacts 16d, 16e printed on the membrane sheet 16, and, after passing through the rubber dome 14, it further slips through the first link member and the second link member 13 to then reach the rear side of the key-top 11. On the key-top 11 there is formed a cutout letter part 11c, which is illuminated with the light. Thus, a letter, character or symbol formed on the upper surface of the key-top 11 is shown up lucently in its shape.

According to the embodiment described above, since the back plate 17 functions as a light guide plate, i.e. highly optical transparency and the LED 18 is packed in the membrane sheet 16 as a light source, the thickness resultant from the LED 18 being mounted can be absorbed in the thickness of a part of the membrane sheet 16 and the back plate 17, and since no additional projection as an illuminating part is produced, the height of the keyboard can be kept low as it is to thereby attain the compatibility with a normal keyboard in respect of profile. Accordingly, it is easy to substitute a keyboard of illuminating type for a normal keyboard, which significantly improves usability.

Further, since the function of a light guide plate is incorporated into the back plate 17, i.e. the light guide and back plate functions are cooperative by the single plate 17, and the LED 18 serving as a light source is mounted in the membrane sheet 16, a key switch of illuminating type is implemented without adding new members for illumination. Accordingly, there is no increase in cost otherwise caused by an increase in number of parts and it is possible to manufacture a keyboard in the process same as conventional.

In the embodiment describe above, the reflecting part 20 is formed in the conical shape, but may not be limited to such a specific shape. For example, the reflecting part may be formed of reflecting dots by printing. Also, uneven shapes may be formed on the upper surface of the back plate 17 or the membrane sheet 16so as to diffuse penetrating light. Further, in the embodiment described above, the light reflector 21 in the plate-like shape is arranged below the back plate 17, but instead of the light reflector 21, the lower surface of the back plate 17 may be coated with reflecting material to form a reflective film. In such a case, the notched hole 17b is masked to prevent the reflecting material from getting inside thereof.

Moreover, in the embodiment described above, the LED 18 is fixedly attached on the upper sheet 16a of the membrane sheet 16, but may not be limited to such a specific structure. For example, the LED 18 may be mounted downward on the undersurface of the lower sheet 16b, as shown in FIG. 8. In such a case, the LED 18 is located in the notched hole 17b formed in the back plate 17, and as a result, the thickness of the LED 18 is absorbed only by the back plate 17. In the latter case, the LED 18 can be made to be about 0.2 mm thick and the back plate 17 is about 0.4 mm, and thus, such a structure is possible.

Still further, as another modified example, as shown in FIG. 9, a sheet 40 dedicated for the LED 18 may be provided between the membrane sheet 16 and the back sheet 17 to thereby absorb the thickness of the LED 18 only by the back plate 17. By arranging so, there is no need of forming wiring in printing for the LED 18 on the membrane sheet 16, thereby bringing about an effect of making the manufacture easier.

The entire disclosure of Japanese patent application No. 2007-270057 filed on Oct. 17, 2007, including the specification, claims, accompanying drawings and abstract of the disclosure is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. A key switch arrangement comprising:
a key-top having an cutout character part formed thereon which is optically transparent;
a membrane sheet optically transparent and having an electric contact;
a plate member optically transparent and arranged under said membrane sheet; and
a light source arranged in said membrane sheet,
said light source emitting light to illuminate the cutout character part on said key-top through said plate member and said membrane sheet.

2. The arrangement as claimed in claim 1, wherein said light source is arranged in said membrane sheet so as to emit light toward said plate member, and the light emitted from said light source penetrates through said plate member to thereafter reach the cutout character part.

3. The arrangement as claimed in claim 1, wherein said light source is arranged between key switches.

4. The arrangement as claimed in claim 1, wherein said membrane sheet comprises an upper sheet, a spacer sheet and a lower sheet, and said light source is arranged in said upper sheet.

5. The arrangement as claimed in claim 4, wherein said spacer, said lower sheet and said plate member have a continuous notch formed, inside which said light source is arranged.

6. The arrangement as claimed in claim 1, wherein said plate member has a reflecting plate arranged on a side opposite to said membrane sheet.

7. The arrangement as claimed in claim 1, further comprising a reflecting part for reflecting toward the cutout character part the light emitted from said light source and penetrating through internal part of said plate member.

8. The arrangement as claimed in claim 1, wherein said membrane sheet comprises an upper sheet, a spacer sheet and a lower sheet, and said light source is arranged in said lower sheet.

9. The arrangement as claimed in claim 8, wherein said plate member has a notch formed, inside which said light source is arranged.

10. The arrangement as claimed in claim 1, further comprising a member dedicated for said light source provided between said membrane sheet and said plate member, and said plate member has a notch formed, said light source being arranged in said member dedicated for said light source.
